(19) United States
(12) Patent Application Publication
(10) Pub. No.: US 2026/0339874 A1
(43) Pub. Date: Oct. 29, 2026

(54) Real-Time Resolution in Identity Graph Data Structures

(71) Applicant: LiveRamp, Inc., San Francisco, CA (US)

(72) Inventors: Lonavath Vamshi Krishna, Suryapet (IN); Shirish Kumar, Sunnyvale, CA (US)

(21) Appl. No.: 19/114,346

(22) PCT Filed: Sep. 25, 2023
(86) PCT No.: PCT/US2023/074991

§ 371 Date: Mar. 21, 2025

Related U.S. Application Data
(60) Provisional application No. 63/412,962, filed on Oct. 4, 2022.

(51) Int. Cl. G06F 13/42

(52) U.S. Cl. CPC G06F 13/42; G06F 2213/40

(57) ABSTRACT

A system and method for incrementally resolving entities without the need to load and analyze an entire identity graph uses sub-sets (blocks) within the graph. A data stream is received from a message bus, which includes discrete events. The events are read and parsed, and data entities are constructed from the data events. A block of the identity graph is identified which is likely to be changed by the new data event, by applying a set of prospecting rules. The data event is matched against the data within the block of the identity graph to perform resolution of the data entity. This incremental approach, which drastically lowers the number of comparisons made in order to find a match, makes the resolution fast enough to work in real time or near real time, even for very large identity graphs.

### CROSS-REFERENCE TO RELATED APPLICATIONS

This application claims the benefit of U.S. provisional patent application No. 63/412,962, filed on Oct. 4, 2022. Such application is incorporated herein by reference in its entirety.

### BACKGROUND

An identity graph is a data structure that contains data for a large collection of objects, such as, for example, consumers. Nodes in the identity graph correspond to touchpoints or data elements for such objects, and edges in the graph connect nodes that correspond to the same object with certain probability. Entity resolution (ER) refers to techniques and tools for identifying and linking different manifestations of the same object. ER may alternatively be referred to as record linkage, duplicate detection, or object consolidation. ER techniques may be used to identify and link objects in an identity graph, such as nodes in the identity graph that pertain to the same consumer within a set of consumers.

As the operator of an identity graph gains more and more data concerning new objects, or more data concerning a particular existing set of objects, the identity graph where this information is stored necessarily becomes larger and larger. The number of nodes, as well as the number of edges connecting these nodes, continues to increase. The time required in order to perform entity resolution within an identity graph is generally correlated to the size of the identity graph, since as the identity graph grows the number of edges that must be traversed and nodes examined during the ER operations increases. Thus the collection of more data slows down entity resolution using conventional searching and matching algorithms.

In certain applications, it is desirable to perform ER operations in real time or near real time. Therefore, growth in the size of an identity graph presents a problem because the identity graph may grow so large that ER operations may no longer be performed within the necessary timeframe. It is therefore desirable to develop a system and method for performing ER operations in an identity graph within a short timeframe, despite the size of the identity graph becoming quite large, in order to support certain real-world applications, in particular those applications that require real-time or near real-time ER operations.

References mentioned in this background section are not admitted to be prior art with respect to the present invention.

### SUMMARY

The present invention is directed to a system and method for incrementally resolving entities without the need to load and analyze an entire identity graph by using sub-sets. This incremental approach makes the resolution fast enough to work in real time or near real time, even for very large identity graphs. For example, the resolution may occur in less than a second in some implementations as opposed to hours in prior art implementations on similarly sized identity graphs. This short time frame becomes important when, for example, data arrives in a continuous stream and resolution is needed to be performed within a few hundred milliseconds in order for entity resolution to keep up with the incoming data stream.

In the application where the identity graph contains information about consumers, real-time entity resolution using certain embodiments of the present invention helps give a complete and accurate picture of consumer activities in real time or near real time. This can help build segments of consumers that are timely and can help improve performance of digital data processing as a result. In addition, this can also help perform timely analysis of customer behavior.

These and other features, objects and advantages of the present invention will become better understood from a consideration of the following detailed description of the preferred embodiments and appended claims in conjunction with the drawings as described following:

### DRAWINGS

FIG. 1 is a schematic showing a message bus and streaming process according to an embodiment of the present invention.

FIG. 2 is a schematic showing a graph database and more detailed view of a streaming process according to an embodiment of the present invention.

FIG. 3 is a data flow diagram for the prospecting process according to an embodiment of the present invention.

FIG. 4 is a diagram of a computer for implementing an embodiment of the present invention.

### DETAILED DESCRIPTION

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

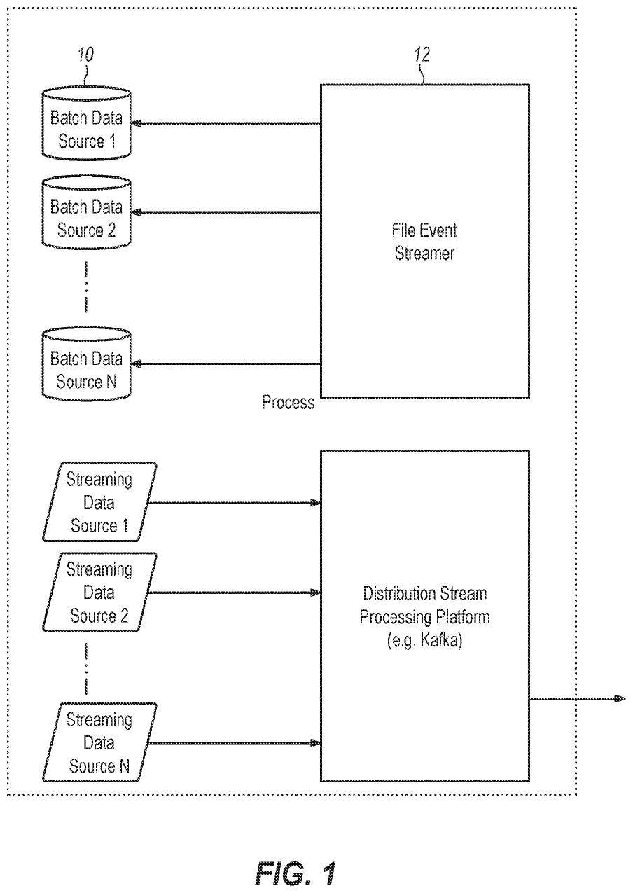

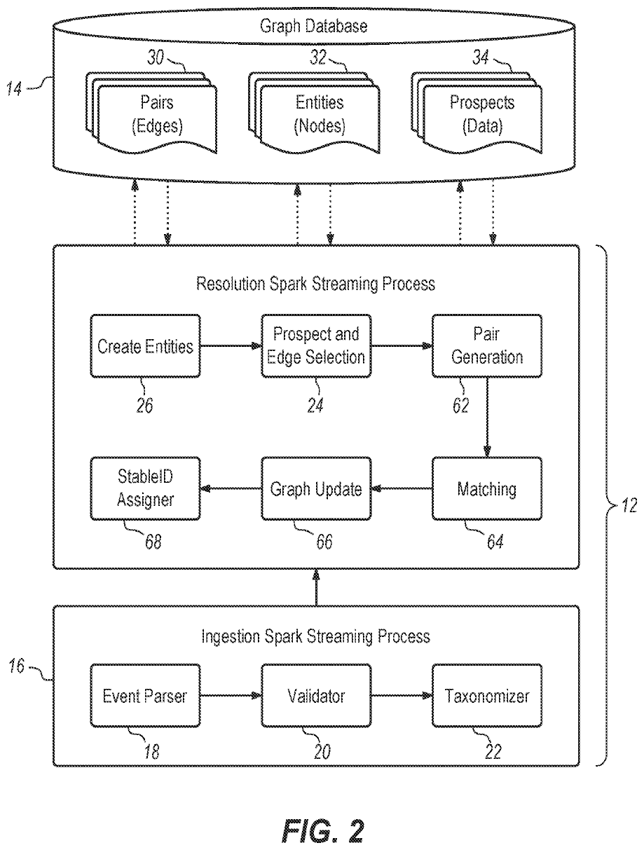

The implementations of the present invention described herein rely upon three components, as shown in FIGS. 1 and 2. One is a message bus 10, which is used to deliver data events. This may be, in some embodiments, real-time delivery of data events, but may also be batch delivery, or both, as shown in FIG. 1. The second is a stream process 12, which provides a computing environment for the various components described herein. The steam process 12 may be implemented, for example, as an Apache Spark engine, using software from Apache Spark Foundation, in a cloud computing environment. The third component is a graph database 14, shown only in FIG. 2, which stores the nodes and edges of the identity graph used in connection with the implementations, as described further herein. Specifically, graph database 14 may contain pairs (edges) 30, entities (nodes) 32, and prospects (data) 34, as described below.

As further shown in FIG. 2, an implementation includes a real-time stream-based data ingestor 16. This component reads records (or data events), parses the records at event parser 18, performs validation at validator 20, and prepares records for resolution. The ingestor may further include a taxonomizer 22, which maps the incoming record to a standard data vocabulary.

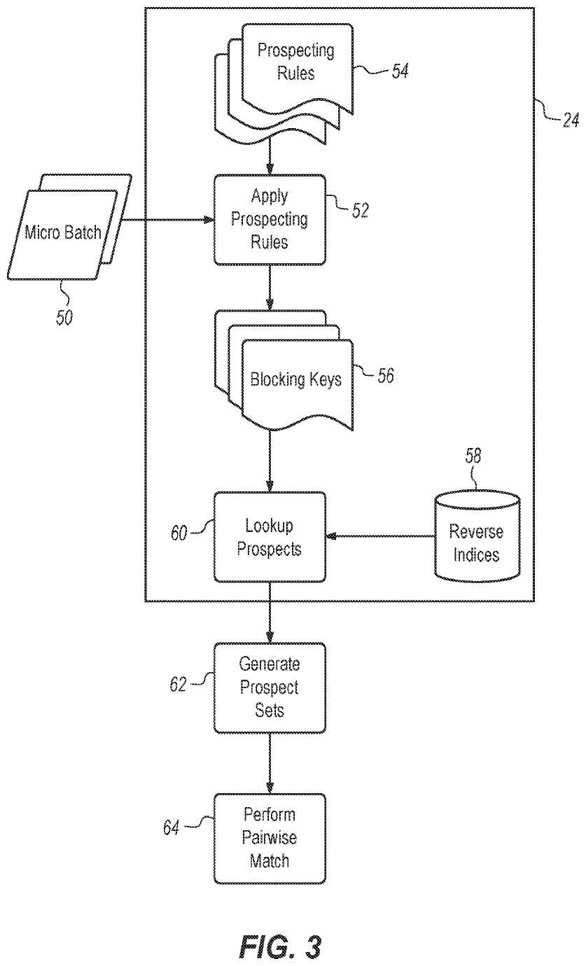

In the stream process, an implementation may include a prospect node and edge selector 24, which receives entities from a create entities process 26. This element is shown in FIG. 1, and FIG. 2 provides a data flow for operation of the prospect node and edge selector 24. This element provides identification of the portion of the identity graphs that are going to likely be affected (i.e., changed) due to the arrival of the new data record/event. This prospecting process, shown in FIG. 3, reduces the number of comparisons (or matches) that must be made to perform resolution, thereby enabling the performance gains of the described implementation of the present invention. Prospecting creates sets of blocks that are matches. It takes input entity descriptions from micro batch 50 (i.e., the reduced section), applies prospecting rules 52, and assigns the entity descriptions to one or more blocks based on prospecting rules 54. The prospecting rules 54 ensure that the resultant block sizes are significantly small subsets of the entire identity graph in graph database 14. At the same time, prospecting rules 54 also ensure that if any two entity descriptions have a chance of referring to the same real-world entity, they end up in at least one of the blocks.

Prospecting is a step that brings together all the likely matches based on blocking keys 56 that the system generates for each input entity. As an example, an email address may be a blocking key 56 in one implementation, such that all entities with the same email address come together in a grouping referred to herein as a block. All of the entities in each block are compared with each other. Thus it follows that a block of size N will lead to N*N=N² comparisons. It may be seen then that reduction of the block size has a dramatic effect on the time required to perform all comparisons.

Using prospecting rules 54, a set of blocking keys 56 are generated for each event from microbatch 50 and maintained in a reverse indices database 58. In this database 58, a blocking key (index) 56 refers to the events it belongs to. For every new microbatch 50 of events that arrive through bus 10, the system applies the same prospecting rules 54 to generate blocking keys 56. The system then performs a look-up in the reverse indices database at lookup prospects process 60 to retrieve events that have the same blocking keys 56. The retrieved events in the existing graph from graph database 14 form the sets of prospects at generate prospect sets 62. For each blocking key from blocking keys 56, the retrieved events are merged with the new ones and the system proceeds with pairwise match process 64. If the matching results in new edges, the system updates the graph 66 at graph database 14 with the new edges. Also, at the end of this processing, the system updates the reverse indices 58 with the new events.

The particular prospecting rules 54 are dependent upon the nature of the data. The prospecting rules 54 may be manually supplied by a data analyst, auto-created by the system, or both, in various implementations of the invention. An analyst can create a prospecting rule 54 by combining two columns. For example, an analyst could combine last name and ZIP code, or last name and telephone number, to create a prospecting rule 54.

In the case where prospecting rules 54 are automatically created by the system, then the following steps may be followed. First, the system creates an ordered string by combining all of the columns of an event. The MinHash algorithm may be applied to generate a signature that represents the event. MinHash is a technique for quickly estimating how similar two sets are without requiring a complete comparison between every element of the two sets. Third, the system applies locality sensitive hashing to generate blocking keys. Locality sensitive hashing is a technique for hashing items into buckets with other items that are highly probable to be similar, again without requiring a complete comparison.

Another implementation of the invention can generate embeddings using the ordered string created by combining all of the columns of an event. These embeddings are vector representations and can be generated using a machine learning (ML) model. These embeddings can be used to perform near neighbor searches to create blocks.

In summary, pair generation 62 generates likely matching pairs of records (events). Then pairwise matcher 64 executes a matching function that compares two events/records and emits a probability of a match. The graph updater 66 provides for the addition of new nodes in the identity graph, the insertion of the matched pairs (edges) 30, or the deletion of existing pairs (edges) 30. The stable ID assigner 68 performs the function of either reusing an existing ID or assigning a new ID. A change log generator generates the changes in the identity graph at graph database 14 due to the resolution process.

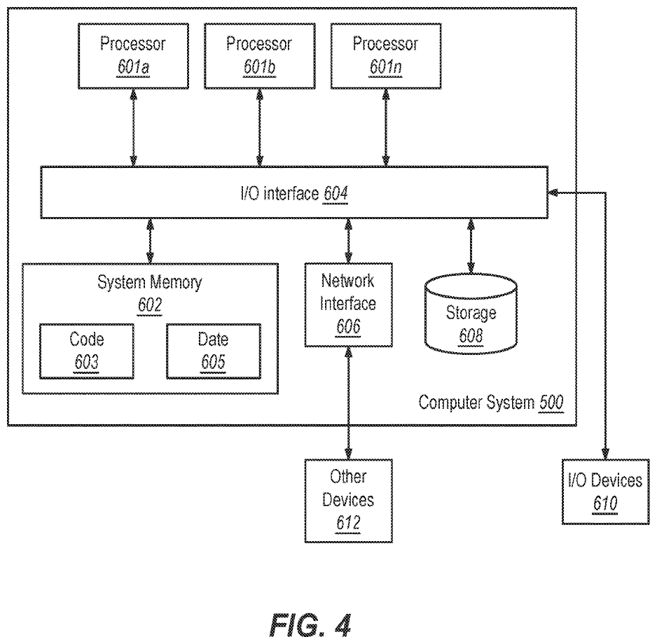

The methods described herein may in various embodiments be implemented by any combination of hardware and software. For example, in one embodiment, the methods may be implemented by a computer system (e.g., a computer system as in FIG. 4) or a collection of computer systems, each of which includes one or more hardware processors executing program instructions stored on a computer-readable physical storage medium coupled to the hardware processors. The program instructions may implement the functionality described herein (e.g., the functionality of various hardware servers and other components that implement the network-based cloud and non-cloud computing resources described herein). The various methods as illustrated in the figures and described herein represent example implementations. The order of any method may be changed, and various elements may be added, modified, or omitted.

FIG. 4 is a block diagram illustrating an example computer hardware system, according to various embodiments. Computer system 500 may implement a hardware portion of a cloud computing system or non-cloud computing system, as forming parts of the various implementations of the present invention. Computer system 500 may be any of various types of hardware devices, including, but not limited to, a commodity server, personal computer system, desktop computer, laptop or notebook computer, mainframe computer system, handheld computer, workstation, network computer, a consumer device, application server, physical storage device, telephone, mobile telephone, or in general any type of computing node, compute node, compute device, and/or hardware computing device.

Computer system 500 includes one or more hardware processors 601a, 601b . . . 601n (any of which may include multiple processing cores, which may be single or multi-threaded) coupled to a physical system memory 602 via an input/output (I/O) interface 604. Computer system 500 further may include a network interface 606 coupled to I/O interface 604. In various embodiments, computer system 500 may be a single processor system including one hardware processor 601a, or a multiprocessor system including multiple hardware processors 601a, 601b . . . 601n as illustrated in FIG. 4. Processors 601a, etc. may be any suitable processors capable of executing computing instructions. For example, in various embodiments, processors 601a, etc. may be general-purpose or embedded processors implementing any of a variety of instruction set architectures. In multiprocessor systems, each of processors 601a, etc. may commonly, but not necessarily, implement the same instruction set. The computer system 500 also includes one or more hardware network communication devices (e.g., network interface 606) for communicating with other systems and/or components over a communications network, such as a local area network, wide area network, or the Internet. For example, a client application executing on system 500 may use network interface 606 to communicate with a server application executing on a single hardware server or on a cluster of hardware servers that implement one or more of the components of the systems described herein in a cloud computing or non-cloud computing environment as implemented in various sub-systems. In another example, an instance of a server application executing on computer system 500 may use network interface 606 to communicate with other instances of an application that may be implemented on other computer systems.

In the illustrated embodiment, computer system 500 also includes one or more physical persistent storage devices 608 and/or one or more I/O devices 610. In various embodiments, persistent storage devices 608 may correspond to disk drives, tape drives, solid-state memory or drives, other mass storage devices, or any other persistent storage devices. Computer system 500 (or a distributed application or operating system operating thereon) may store instructions and/or data in persistent storage devices 608, as desired, and may retrieve the stored instructions and/or data as needed. For example, in some embodiments, computer system 500 may implement one or more nodes of a control plane or control system, and persistent storage 608 may include the solid-state drives (SSDs) attached to that server node. Multiple computer systems 500 may share the same persistent storage devices 608 or may share a pool of persistent storage devices, with the devices in the pool representing the same or different storage technologies, including such technologies as described above.

Computer system 500 includes one or more physical system memories 602 that may store code/instructions 603 and data 605 accessible by processor(s) 601a, etc. The system memories 602 may include multiple levels of memory and memory caches in a system designed to swap information in memories based on access speed, for example. The interleaving and swapping may extend to persistent storage devices 608 in a virtual memory implementation, where memory space is mapped onto the persistent storage devices 608. The technologies used to implement the system memories 602 may include, by way of example, static random-access memory (RAM), dynamic RAM, read-only memory (ROM), non-volatile memory, solid-state memory, or flash-type memory. As with persistent storage devices 608, multiple computer systems 500 may share the same system memories 602 or may share a pool of system memories 602. System memory or memories 602 may contain program instructions 603 that are executable by processor(s) 601a, etc. to implement the routines described herein.

In various embodiments, program instructions 603 may be encoded in binary, Assembly language, any interpreted language such as Java, compiled languages such as C/C++, or in any combination thereof; the particular languages given here are only examples. In some embodiments, program instructions 603 may implement multiple separate clients, server nodes, and/or other components.

In some implementations, program instructions 603 may include instructions executable to implement an operating system (not shown), which may be any of various operating systems, such as UNIX, LINUX, Solaris™, MacOS™, or Microsoft Windows™. Any or all of program instructions 603 may be provided as a computer program product, or software, that may include a non-transitory computer-readable storage medium having stored thereon instructions, which may be used to program a computer system (or other electronic devices) to perform a process according to various implementations. A non-transitory computer-readable storage medium may include any mechanism for storing information in a form (e.g., software or processing application) readable by a machine (e.g., a physical computer). Generally speaking, a non-transitory computer-accessible medium may include computer-readable storage media or memory media such as magnetic or optical media, e.g., disk or DVD/CD-ROM, coupled to or in communication with computer system 500 via I/O interface 604. A non-transitory computer-readable storage medium may also include any volatile or non-volatile media such as RAM or ROM that may be included in some embodiments of computer system 500 as system memory 602 or another type of memory. In other implementations, program instructions may be communicated using optical, acoustical or other form of propagated signals (e.g., carrier waves, infrared signals, digital signals, etc.) conveyed via a communication medium such as a network and/or a wired or wireless link, such as may be implemented via network interface 606. Network interface 606 may be used to interface with other devices 612, which may include other computer systems or any type of external electronic device.

In some embodiments, system memory 602 may include data store 605, as described herein. In general, system memory 602 and persistent storage 608 may be accessible on other devices 602 through a network and may store data blocks, replicas of data blocks, metadata associated with data blocks, and/or their state, database configuration information, and/or any other information usable in implementing the routines described herein.

In one embodiment, I/O interface 604 may coordinate I/O traffic between processors 601a, etc., system memory 602, and any peripheral devices in the system, including through network interface 606 or other peripheral interfaces. In some embodiments, I/O interface 604 may perform any necessary protocol, timing or other data transformations to convert data signals from one component (e.g., system memory 602) into a format suitable for use by another component (e.g., processors 601a, etc.). In some embodiments, I/O interface 604 may include support for devices attached through various types of peripheral buses, such as a variant of the Peripheral Component Interconnect (PCI) bus standard or the Universal Serial Bus (USB) standard, as examples. Also, in some embodiments, some or all of the functionality of I/O interface 604, such as an interface to system memory 602, may be incorporated directly into processor(s) 601a, etc.

Network interface 606 may allow data to be exchanged between computer system 500 and other devices attached to a network, such as other computer systems (which may implement one or more storage system server nodes, primary nodes, read-only node nodes, and/or clients of the database systems described herein), for example. In addition, I/O interface 604 may allow communication between computer system 500 and various I/O devices 610 and/or remote storage 608. Input/output devices 610 may, in some embodiments, include one or more display terminals, keyboards, keypads, touchpads, scanning devices, voice or optical recognition devices, or any other devices suitable for entering or retrieving data by one or more computer systems 500. These may connect directly to a particular computer system 500 or generally connect to multiple computer systems 500 in a cloud computing environment, grid computing environment, or other system involving multiple computer systems 500. Multiple input/output devices 610 may be present in communication with computer system 500 or may be distributed on various nodes of a distributed system that includes computer system 500. In some embodiments, similar input/output devices may be separate from computer system 500 and may interact with one or more nodes of a distributed system that includes computer system 500 through a wired or wireless connection, such as over network interface 106. Network interface 106 may commonly support one or more wireless networking protocols (e.g., Wi-Fi/IEEE 802.11, or another wireless networking standard). Network interface 106 may support communication via any suitable wired or wireless general data networks, such as other types of Ethernet networks, for example. Additionally, network interface 106 may support communication via telecommunications/telephony networks such as analog voice networks or digital fiber communications networks, via storage area networks such as Fibre Channel SANs, or via any other suitable type of network and/or protocol. In various embodiments, computer system 500 may include more, fewer, or different components than those illustrated in FIG. 3 (e.g., displays, video cards, audio cards, peripheral devices, or an Ethernet interface).

Any of the distributed system embodiments described herein, or any of their components, may be implemented as one or more network-based services in the cloud computing environment. For example, a read-write node and/or read-only nodes within the database tier of a hardware database system may present database services and/or other types of physical data storage services that employ the distributed storage systems described herein to clients as network-based services. In some embodiments, a network-based service may be implemented by a software and/or hardware system designed to support interoperable machine-to-machine interaction over a network. A web service may have an interface described in a machine-processable format. Other systems may interact with the network-based service in a manner prescribed by the description of the network-based service's interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol. To perform a network-based services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP).

In some embodiments, network-based services may be implemented using Representational State Transfer (REST) techniques rather than message-based techniques. For example, a network-based service implemented according to a REST technique may be invoked through parameters included within an HTTP method such as PUT, GET, or DELETE.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a grouping is used herein, all individual members of the group and all combinations and subcombinations possible of the group are intended to be individually included. When a range is stated herein, the range is intended to include all sub-ranges within the range, as well as all individual points within the range. When “about,” “approximately,” or like terms are used herein, they are intended to include amounts, measurements, or the like that do not depart significantly from the expressly stated amount, measurement, or the like, such that the stated purpose of the apparatus or process is not lost. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

1. A method for resolution, comprising the steps of:
delivering a data stream at a message bus, wherein the data stream comprises a plurality of data events;
reading and parsing the plurality of data events;
creating a data entity from at least one of the plurality of data events;
in an identity graph in a graph database, identifying a block of the identity graph that is likely to be changed by entry of the data entity in the identity graph by applying a set of prospecting rules; and
matching the data entity against the block of the identity graph to perform resolution of the data entity.

2. The method of claim 1, wherein the plurality of data events are delivered at the message bus in real time.

3. The method of claim 1, wherein the plurality of data events are delivered at the message bus in a batch mode.

4. The method of claim 1, further comprising the steps of validating the plurality of data events and mapping the plurality of data events to a standard data vocabulary.

5. The method of claim 1, wherein the step of identifying a block of the identity graph that is likely to be changed by entry of the data entity comprises the step of applying a blocking key from a set of blocking keys.

6. The method of claim 5, further comprising the step of storing the set of blocking keys in a reverse indices database, and performing a look-up in the reverse indices database to identify each data entity with the same blocking key.

7. The method of claim 6, further comprising the step of generating prospecting sets and performing pairwise matching, then updating the identity graph with any new edges resulting from the pairwise matching.

8. The method of claim 7, further comprising the step of ensuring that any two of the entity descriptions that refer to a same real-world entity are assigned to the same block.

9. A computerized resolution system, comprising:
a message bus configured to deliver a plurality of data events;
a graph database comprising an identity graph;
a stream process in communication with the message bus and the graph database, wherein the stream process comprises one or more computer processors and a memory space having instructions stored therein, the instructions, when executed by the one or more computer processors, causing the one or more computer processors to:
read and parse the plurality of data events;
create a data entity from at least one of the plurality of data events;
apply a set of prospecting rules to identify a block of the identity graph that is likely to be changed by entry of the data entity in the identity graph; and
match the data entity against the block of the identity graph to perform resolution of the data entity.

10. The system of claim 9, wherein the message bus is configured to perform real-time delivery of the plurality of data events.

11. The system of claim 9, wherein the message bus is configured to perform batch delivery of the plurality of data events.

12. The system of claim 9, wherein the instructions, when executed by the one or more computer processors, further cause the one or more computer processors to validate the plurality of data events and map each of the plurality of data events to a standard data vocabulary.

13. The system of claim 9, wherein the instructions, when executed by the one or more computer processors, further cause the one or more computer processors to apply a blocking key from a set of blocking keys to the block.

14. The system of claim 13, further comprising a reverse indices database for storing the set of blocking keys, and wherein the reverse indices database is configured to perform a look-up to identify each data entity with the same blocking key.

15. The system of claim 14, wherein the instructions, when executed by the one or more computer processors, further cause the one or more computer processors to generate prospecting sets and perform pairwise matching, then update the identity graph with any new edges resulting from the pairwise matching.

16. The method of claim 13, wherein the instructions, when executed by the one or more computer processors, further cause the one or more computer processors to ensure that any two of the entity descriptions that refer to a same real-world entity are assigned to the same block.

17. A machine-readable non-transitory physical medium storing machine-readable instructions that, when executed, cause a computer to:
receive a data stream from a message bus, wherein the data stream comprises a plurality of data events;
read and parse the plurality of data events;
create a data entity from at least one of the plurality of data events;
in an identity graph in a graph database, identify a block of the identity graph that is likely to be changed by entry of the data entity in the identity graph by applying a set of prospecting rules; and
match the data entity against the block of the identity graph to perform resolution of the data entity.

18. The machine-readable non-transitory physical medium of claim 17, wherein the stored machine-readable instructions, when executed, further cause a computer to apply a blocking key from a set of blocking keys to the block.

19. The machine-readable non-transitory physical medium of claim 18, wherein the stored machine-readable instructions, when executed, further cause a computer to store the set of blocking keys in a reverse indices database, and performing a look-up in the reverse indices database to identify each data entity with the same blocking key.

20. The machine-readable non-transitory physical medium of claim 19, wherein the stored machine-readable instructions, when executed, further cause a computer to generate prospecting sets and perform pairwise matching, then updating the identity graph with any new edges resulting from the pairwise matching.
